(19) United States
(12) Patent Application Publication
(10) Pub. No.: US 2016/0250722 A1
(43) Pub. Date: Sep. 1, 2016

(54) HIGH-CONCENTRATION FLUX FOR BEING SPRAYED ON PREFORM

(71) Applicant: GUANGZHOU SOLDERWELL ADVANCED MATERIALS CO., LTD., Guangzhou, Guangdong (CN)

(72) Inventors: Kun Du, Guangzhou, Guangdong (CN); Fuhua Ye, Guangzhou, Guangdong (CN); Hua Han, Guangzhou, Guangdong (CN); Yan Lu, Guangzhou, Guangdong (CN); Jinye Zhao, Guangzhou, Guangdong (CN); Yaolin Huang, Guangzhou, Guangdong (CN); Minghan Chen, Guangzhou, Guangdong (CN)

(21) Appl. No.: 15/031,283

(22) PCT Filed: Dec. 30, 2013
(86) PCT No.: PCT/CN2013/090917

§ 371 Date: Apr. 22, 2016

(30) Foreign Application Priority Data
Oct. 25, 2013 (CN) 201310509895.7

(51) Int. Cl. B23K 35/362; B23K 35/36

(52) U.S. Cl. CPC B23K 35/362; B23K 35/3613; B23K 35/3618; B23K 35/3615; B23K 35/3612

(57) ABSTRACT

The present invention provides a high-concentration flux for being sprayed on a preform. The flux has a composition comprising, based on weight percent, 35-50% of a film-forming agent, 1-20% of an active substance, 0.1-1.5% of a surfactant, and 0.005-0.02% of a dye, with the balance being a solvent. The flux has the advantages of excellent coating performance, highly controllable coating amount, high activity, and low active substance residue after welding, and is suitable for the efficient spraying process and highly reliable welding of various preforms.

### FIELD OF THE INVENTION

The present invention relates to the field of flux, and particularly to a flux for being sprayed on a preform, which is particularly suitable for efficient spraying process and highly reliable welding of various preforms.

### BACKGROUND OF THE INVENTION

Preform is a precisely formed solder that is fabricated, as desired, to have different shapes, sizes and surface morphologies, suitable for use in various manufacturing processes requiring a small tolerance, and widely used in printed circuit board (PCB) assembly, connector and terminal equipment, chip connection, attachment of power supply modules to a substrate, assembly of filter coupler and electronic components, and other areas. Therefore, the preform is generally utilized in a situation where the shape and quality of the solder are particularly required, and may be fabricated into any size and shape to meet the customer's requirements. Due to the advantages such as shape diversity, good weldability, reduced splashing of flux, and accurately controllable amount of metal when used alone, the preform is regarded as an important means in the technical innovation of welding.

To achieve a desirable effect of precise welding, the preform generally needs to be coated with a suitable flux. The coating of the flux should be accurate and even, and the coating amount should be adequate. The production efficiency may be improved by coating the flux by means of spraying. However, a low-concentration flux is unlikely to form a film with adequate thickness on the surface of the preform, and the quality and activity of the formed film are difficult to meet the welding requirements.

There are a few disclosed patents that present the flux for preform coating.

CN 103056556A provides a preform with a halogen-free flux coated on a surface thereof. The halogen-free liquid flux has a composition comprising, on a weight basis: 35-42% of a carrier, 1.0-1.4% of a surfactant, 0.5-1.2% of a leveler, 0.3-0.5% of an active agent, 0.1-1.0% of a resin film-forming agent, and 0.15-1.2% of a thickener, with the balance being an organic solvent. The carrier is rosin; the surfactant is T-80, TX-100, and Span 60; the leveler is OP-10; the active agent is oxalic acid, salicylic acid, and malic acid; the resin film-forming agent is polybutadiene and polyurethane; the thickener is hydrogenated castor oil; the organic solvent is an alcohol or ketone with boiling point less than 110° C. Based on the weight of the preform coated with the flux, the flux coating is present in an amount of 0.2-5.0%.

U.S. Pat. No. 5,932,030 discloses a flux for use in conjuction with a preform, which comprises rosin, N-substituted or N-unsubstituted-2-pyrrolidone, and a transparent high-boiling point ester solvent. The N-substituted or N-unsubstituted-2-pyrrolidone is present in an amount of 3-50% by weight, and the ester solvent is present in an amount of not greater than 30% by weight.

U.S. Pat. No. 5,984,161 discloses a resilient flux-cladded preform and a process for the preparation thereof. The resilient flux cladding layer for the preform is formed by mixing 1) 5-30 wt % of potassium silicate, in which the molar ratio of K₂O:SiO₂=1:1.25−1.45; 2) 0.5-10 wt % of concentrated phosphoric acid; 3) 0.1-5 wt % of boric acid; 4) 0-10 wt % of fine silica powder; and 5) the balance of water as a binder.

The above patents all have respective features, but the following defects still exist.

1) The coating amount and uniformity of the flux are not easy to be controlled, and the coating amount is inadequate especially for a preform with a small specific surface area, such that the flux is unsuitable for a high-efficiency coating process.

2) The flux has a low activity a narrow application range.

### SUMMARY OF THE INVENTION

In view of the disadvantages of the above proprietary techniques in the prior art, the present invention provides a high-concentration flux for being sprayed on a preform. The flux has the advantages of excellent coating performance, highly controllable coating amount, high activity, and low active substance residue after welding.

To solve the above technical problems, the following technical solutions are employed in the present invention. A high-concentration flux for being sprayed on a preform is provided, which has a composition comprising, based on weight percent, 35-50% of a film-forming agent, 1-20% of an active substance, 0.1-1.5% of a surfactant, and 0.005-0.02% of a dye, with the balance being a solvent.

As an improvement of the present invention, the film-forming agent in the present invention is present in an amount of 40-45% by weight, the active substance is present in an amount of 5-20% by weight, the surfactant is present in an amount of 0.1-1% by weight, and the dye is present in an amount of 0.005-0.01% by weight.

As an improvement of the present invention, the film-forming agent in the present invention comprises at least one of rosin, polyethylene glycol, acrylic resin, acrylamide resin, phenolic resin, and alkyd resin.

As an improvement of the present invention, the rosinin in the present invention comprises at least one of hydrogenated rosin, water-white rosin, maleated rosin and acrylic-modified rosin.

As an improvement of the present invention, the active substance in the present invention comprises at least one of succinic acid, dibromo succinic acid, adipic acid, sebacic acid, aspartic acid, glutamic acid, lactic acid, tartaric acid, salicylic acid, and a salt formed of an organic amine and an acid.

As an improvement of the present invention, the organic amine in the present invention has a basicity factor pK_{b} (or pK_{b1}) that is less than or equal to 4.5.

As an improvement of the present invention, the acid in the present invention has an acidity coefficient pKₐ (or pKₐ₁) that is less than or equal to 4.5.

As an improvement of the present invention, the surfactant in the present invention comprises at least one of polyoxyethylene alkyl phenyl ethers TX-10 and OP-10, fatty alcohol polyoxyethylene ethers AE0-3 and AE0-9, nonionic fluorocarbon surfactants FSN-100 and FC-4430, and dibromobutenediol.

As an improvement of the present invention, the dye in the present invention comprises an azo and a triphenylmethane dye.

As an improvement of the present invention, the solvent in the present invention comprises at least one of ethanol, isopropanol, butanol, ethylene glycol methyl ether, and butyl acetate.

In the present invention, a film-forming agent that has a high binding force to the preform is used. The film-forming agent has a stable chemical property at normal temperature, is unlikely to fall off during the spraying and film forming process, and has a binding force that is not decreased obviously after long period (for example, 1 year) of storage.

The active substance is substantially inactive at a low temperature, and can effective remove the oxide film on and prevent the further oxidation of the face of weld when being heated to a welding temperature. A salt formed of an organic amine and an acid is an active substance with good performances, and the activity of which may be adjusted with different organic amines and acids, thus being a preferred active substance in the present invention. Moreover, when the salt is used in combination with an organic acid, a synergistic effect is produced, and the effect is much better. In addition, the active substance used in the present invention may be screened and combined according to the metal material to be welded, the type of the soldering lug alloy and the welding process, to allow it to be completely decomposed upon melting of the solder or completion of the welding, thus ensuring the low active substance residue and high reliability after welding.

To allow the preform to spread fully during the welding process, one or more surfactants are added in the present invention to reduce the surface tension of the solder.

The addition of a small amount of dye to the flux can facilitate the determination of the coating amount and uniformity of the flux on the surface of the preform, thereby increasing the controllability of the coating with the flux. The azo and triphenylmethane dyes have a quite good dyeing and recognition effect on the flux, and thus are preferred in the present invention.

The solvent is a component essential to the formulation of the flux, and a component needed to be removed during the film-forming process of the flux, which requires that the solvent has not only a good dissolvability for the film-forming agent (e.g. rosin) and other components, but also a proper volatilization rate during drying to form a film. A too large volatilization rate may lead to the occurrence of pinholes, wrinkles, and cracks on the flux film, and a too small volatilization rate may lead to tackiness, thickened edge, and other drawbacks. In the present invention, low-boiling point and highly volatile ethanol and isopropanol, and high-boiling point and less volatile butanol, ethylene glycol methyl ether, and butyl acetate are used as the solvent, which may be appropriately combined to meet the practical requirements. Moreover, the solvent used has the advantages of high dissolvability, low toxicity, and low cost.

Compared with the prior art, the present invention has considerable beneficial effects. The film-forming agent and solvent used in the present invention have good coating performance, and are inexpensive and environmental friendly. The controllability of the coating with the flux is increased by adding the dye, which highly coincides with the high precision requirement for the preform during use. The active substance may be screened and combined to adjust the activity, and thus has a broad application range. The high concentration of nonvolatile ingredients (where the weight ratio of the nonvolatile ingredients to the solvent may be up to 6:4) ensures that the coating amount is adequate after the preform with a small specific surface area is coated with the flux. After welding, the amount of active substance residue is small, and no cleaning is required. Therefore, the flux is suitable for the efficient spraying process and highly reliable welding of various preforms.

### DETAILED DESCRIPTION OF THE EMBODIMENTS

### Example 1

The flux of the present invention has a composition comprising, based on weight percent:

film-forming agent: hydrogenated rosin 40%

active substance: succinic acid 2%

adipic acid 4%

salicylic acid 2%

cyclohexylamine hydrochloride 1%

surfactant: TX-10 0.2%

dibromobutenediol 0.4%

dye: arsenazo 0.01%

solvent: ethanol 35%

ethylene glycol methyl ether 15.4%

The above ingredients were mixed until uniform at normal temperature to prepare a liquid flux, which was coated onto a rectangular SnCu0.7 preform by spraying, and dried at 80° C. The flux film on the fabricated preform has a uniform thickness, a high binding force, and a good wettability to the preform during welding. After welding, the amount of active substance residue is small.

### Example 2

The flux of the present invention has a composition comprising, based on weight percent:

film-forming agent: water-white rosin 40%

polyethylene glycol 8%

alkyd resin 2%

active substance: diethylamine p-methylbenznesulfonate 1%

surfactant: AEO-9 0.5%

dibromobutenediol 1%

dye: ethyl violet 0.02%

solvent: isopropanol 35%

butanol 12.5%

The above ingredients were mixed until uniform at normal temperature to prepare a liquid flux, which was coated onto a round SnAg3Cu0.5 preform by spraying, and dried at 80° C. The flux film on the fabricated preform has a uniform thickness, a high binding force, and a good wettability to the preform during welding. After welding, the amount of active substance residue is small.

### Example 3

The flux of the present invention has a composition comprising, based on weight percent:

film-forming agent: hydrogenated rosin 30%

maleated rosin 3%

phenolic resin 2%

active substance: dibromosuccinic acid 4%

aspartic acid 4%

lactic acid 2%

dimethylamine malonate 4%

surfactant: FSN-100 0.5%

dibromobutenediol 0.5%

dye: crystal violet 0.005%

solvent: ethanol 35%

butyl acetate 15%

The above ingredients were mixed until uniform at normal temperature to prepare a liquid flux, which was coated onto a circular SnCu2 preform by spraying, and dried at 80° C. The flux film on the fabricated preform has a uniform thickness, a high binding force, and a good wettability to the preform during welding. After welding, the amount of active substance residue is small.

### Example 4

The flux of the present invention has a composition comprising, based on weight percent:

film-forming agent: water-white rosin 30%

acrylic-modified rosin 5%

acrylic resin 5%

active substance: dibromosuccinic acid 2%

sebacic acid 4%

glutamic acid 2%

tartaric acid 4%

ethanolamine citrate 8%

surfactant: FC-4430 0.1%

dye: brilliant green 0.01%

solvent: ethanol 25%

ethylene glycol methyl ether 14.9%

The above ingredients were mixed until uniform at normal temperature to prepare a liquid flux, which was coated onto a U-shaped SnSb5 preform by spraying, and dried at 80° C. The flux film on the fabricated preform has a uniform thickness, a high binding force, and a good wettability to the preform during welding. After welding, the amount of active substance residue is small.

It should be noted that the foregoing descriptions are merely preferred embodiments of the present invention, and the protection scope of the present invention is not limited thereto. Replacements made simply by those of skill in the art based on the embodiments are all embraced in the protection scope as defined by the claims of present invention.

What is claimed is:

1. A high-concentration flux for being sprayed on a preform, having a composition comprising 35-50% of a film-forming agent, 1-20% of an active substance, 0.1-1.5% of a surfactant, and 0.005-0.02% of a dye, with the balance being a solvent.

2. The high-concentration flux for being sprayed on a preform according to claim 1, wherein the film-forming agent comprises at least one of rosin, polyethylene glycol, acrylic resin, acrylamide resin, phenolic resin, and alkyd resin.

3. The high-concentration flux for being sprayed on a preform according to claim 2, wherein the rosin comprises at least one of hydrogenated rosin, water-white rosin, maleated rosin and acrylic-modified rosin.

4. The high-concentration flux for being sprayed on a preform according to claim 1, wherein the active substance comprises at least one of succinic acid, dibromosuccinic acid, adipic acid, sebacic acid, aspartic acid, glutamic acid, lactic acid, tartaric acid, salicylic acid, and a salt formed of an organic amine and an acid.

5. The high-concentration flux for being sprayed on a preform according to claim 4, wherein the organic amine has a basicity coefficient pK_{b} (or pK_{b1}) that is less than or equal to 4.5.

6. The high-concentration flux for being sprayed on a preform according to claim 4, wherein the acid has an acidity coefficient pKₐ (or pKₐ₁) that is less than or equal to 4.5.

7. The high-concentration flux for being sprayed on a preform according to claim 1, wherein the surfactant comprises at least one of polyoxyethylene alkyl phenyl ethers TX-10 and OP-10, fatty alcohol polyoxyethylene ethers AE0-3 and AE0-9, nonionic fluorocarbon surfactants FSN-100 and FC-4430, and dibromobutenediol.

8. The high-concentration flux for being sprayed on a preform according to claim 1, wherein the dye comprises an azo and a triphenylmethane dye.

9. The high-concentration flux for being sprayed on a preform according to claim 1, wherein the solvent comprises at least one of ethanol, isopropanol, butanol, ethylene glycol methyl ether, and butyl acetate.
